(19) United States
(12) Patent Application Publication
(10) Pub. No.: US 2026/0116804 A1
(43) Pub. Date: Apr. 30, 2026

(54) MOLDING MOLD AND METHOD FOR MANUFACTURING GLASS LENS

(71) Applicant: AAC Optics (Chongqing) Co., Ltd., Chongqing (CN)

(72) Inventors: Linzhi Zhao, Shenzhen (CN); Jian Wang, Shenzhen (CN)

(21) Appl. No.: 19/344,597

(22) Filed: Sep. 30, 2025

Related U.S. Application Data
(63) Continuation-in-part of application No. 18/088,639, filed on Dec. 26, 2022, now abandoned.
Application No. 18/088,639 is a continuation of application No. PCT/CN2022/119109, filed on Sep. 15, 2022.

(30) Foreign Application Priority Data
Aug. 22, 2022 (CN) 202222209059.4

(51) Int. Cl. C03B 11/08

(52) U.S. Cl. CPC C03B 11/088; C03B 11/082; C03B 2215/414; C03B 2215/69

(57) ABSTRACT

A molding mold and a method for manufacturing a glass lens is provided. The molding mold includes a first pressing mold having a first surface and a second pressing mold having a second surface. The first surface is provided with a plurality of first molding portions for molding glass lenses and the second surface is provided with a plurality of second molding portions for molding glass lenses. The first pressing mold includes first flow baffles, close to a peripheral area of the first pressing mold, and protrude from the first surface towards the second pressing mold. The first flow baffle is configured to restrict glass flow during a hot-pressing process, so as to balance molding pressure of the molding mold from a center to the peripheral area. The disclosure achieves a technical effect of increasing a peripheral molding pressure of the mold and improving yield of products.

### CROSS REFERENCE TO RELATED APPLICATIONS

The present application is a continuation-in-part of U.S. Application No. 18088639, filed on December 26, 2022, which is a continuation of PCT Patent Application No. PCT/CN2022/119109, filed September 15, 2022, which claims priority to Chinese patent application No. 202222209059.4, filed August 22, 2022, all of the aforementioned patent applications are incorporated by reference herein in their entirety.

### TECHNICAL FIELD

The disclosure relates to the field of lens technologies, in particular, to a molding mold, and a method for manufacturing a glass lens.

### BACKGROUND

As apertures of cameras in mobile phones are getting larger, sizes of the cameras are getting smaller, and the mobile phones are becoming lighter, higher requirements are put forward for the lenses. Performance of traditional plastic lenses is hard to be improved further, while glass lenses can be further improved to break bottlenecks that current mobile phone lenses face.

At present, in existing optical technologies, the lens is made through thermoforming by using a glass processing mold. After the glass processing mold is closed, a mold body may define a space having a preset shape. The space is used to define a shape of a glass material being heated, to lead to forming a glass product. A formed glass product may be cut into separate lenses in a corresponding region to form a plurality of lenses. However, there is not sufficient molding pressure on a periphery of the mold during manufacturing, and thus the molding pressure at the center and periphery may be unbalanced. In addition, it is easy to result in poor molded appearance where a periphery of a lens is foggy or there is a bubble in the periphery of the lens, and poor yield of products during manufacturing.

As such, in current lens technology, insufficient peripheral molding pressure of the mold and poor yield of the products are existed.

### SUMMARY

The disclosure aims to solve technical problems of insufficient peripheral molding pressure of a mold and poor yield of lens products.

To address technical problems described above, the disclosure provides a molding mold. The molding mold includes a first pressing mold and a second pressing mold. The first pressing mold has a first surface facing the second pressing mold, and the second pressing mold has a second surface facing the first pressing mold. The first surface of the first pressing mold is provided with a plurality of first molding portions for molding glass lenses, and the second surface of the second pressing mold is provided with a plurality of second molding portions for molding the glass lenses. Each of the plurality of first molding portions and one of the plurality of second molding portions aligned therewith cooperate to define a lens cavity. The first pressing mold further includes a plurality of first connection portions, and any two adjacent first molding portions among the plurality of first molding portions are connected through one of the plurality of first connection portions located therebetween, so that the first surface forms a continuous molding surface for hot-pressing an entire sheet of flat glass. The plurality of first molding portions and the plurality of first connection portions are integrally formed. The second pressing mold further includes a plurality of second connection portions, and any two adjacent second molding portions among the plurality of second molding portions are connected through one of the plurality of second connection portions located therebetween, so that the second surface forms a continuous molding surface for hot-pressing the entire sheet of flat glass in cooperation with the first surface. The plurality of second molding portions and the plurality of second connection portions are integrally formed. The first pressing mold further includes a plurality of first flow baffles spaced apart from each other, the plurality of first flow baffles are disposed on a peripheral area of the first pressing mold and protrude towards the second pressing mold from the first surface, and the plurality of first flow baffles are configured to restrict glass flow during a hot-pressing process, so as to balance molding pressure of the molding mold from a center to the peripheral area.

Further, the second pressing mold further includes a plurality of second flow baffles spaced apart from each other, and the plurality of second flow baffles are provided corresponding to the plurality of first flow baffles.

Further, the plurality of second flow baffles protrude towards the first pressing mold from the second surface.

Further, the plurality of second flow baffles are recessed in the second surface in a direction away from the first pressing mold. A size of each of the first flow baffles protruding from the first surface is greater than a size of a corresponding second flow baffle of the second flow baffles recessed in the second surface.

Further, in a direction perpendicular to the first surface, a junction of each of the plurality of first flow baffles and the first surface has a circular shape or a fan-ring shape.

Further, there are an even number of first flow baffles, and the even number of first flow baffles are provided around a center of the first surface.

Further, in a direction perpendicular to the second surface, a junction of each of the plurality of second flow baffles and the second surface has a circular shape or a fan-ring shape.

Further, there are an even number of second flow baffles, and the even number of second flow baffles are provided around a center of the second surface.

The disclosure further provides a method for manufacturing a glass lens, including: providing a molding mold as described above; placing an entire sheet of flat glass between the first pressing mold and the second pressing mold; closing the molding mold and heating the molding mold, so that the flat glass softens and is pressed at the plurality of first molding portions and the plurality of second molding portions to form a plurality of lenses, where the plurality of first flow baffles are configured to restrict a flow of the softened flat glass during a hot-pressing process, so as to balance molding pressure of the molding mold from a center to the peripheral area; opening the molding mold and taking out the molded plurality of lenses; and separating individual lenses by laser cutting.

The embodiments of the disclosure have following advantageous effects.

In the molding mold and the method for manufacturing a glass lens, any two adjacent first molding portions among a plurality of first molding portions are connected to each other via a first connection portion located therebetween, such that the first surface forms a continuous molding surface for hot-pressing an entire sheet of flat glass, and the plurality of first molding portions and the plurality of first connection portions are integrally formed; and any two adjacent second molding portions among a plurality of second molding portions are connected to each other via a second connection portion located therebetween, such that the second surface forms a continuous molding surface for hot-pressing an entire sheet of flat glass in cooperation with the first surface, and the plurality of second molding portions and the plurality of second connection portions are integrally formed. Thus, the molding mold can press an entire sheet of glass at once to form a lens array. In addition, a plurality of first flow baffles are disposed on a peripheral area of the first pressing mold, and protrude towards the second pressing mold from the first surface. In this way, by providing the plurality of first flow baffles outside the cavity regions of the first molding portions and the second molding portions, glass may be prevented from flowing toward external directions of the molding regions, so that molding pressures outside the molding regions during manufacturing of lenses can be increased, thereby increasing a peripheral molding pressure of the molding mold. This results in an increase in the molding pressure at the peripheral area of the molding mold, thereby achieving a balance between the molding pressures in the central and peripheral areas, thus contributing to an improved product yield.

### BRIEF DESCRIPTION OF DRAWINGS

In order to illustrate the technical solutions in the embodiments of the disclosure or in the existing technologies more clearly, the drawings used in the description of the embodiments will be briefly described below. It is obvious that the drawings in the following description are only some embodiments of the disclosure. For those skilled in the art, other drawings may also be obtained in accordance with the drawings without any inventive effort.

FIG. 1 is a schematic view of a molding mold according to according to embodiments of the disclosure.

FIG. 2 is a schematic view of a molding mold according to other embodiments of the disclosure.

FIG. 3 is a first schematic view of a first flow baffle and a second hydraulic resistance in a molding mold according to embodiments of the disclosure.

FIG. 4 is a second schematic view of the first flow baffle and the second hydraulic resistance in the molding mold according to other embodiments of the disclosure.

FIG. 5 is a third schematic view of the first flow baffle and the second hydraulic resistance in the molding mold according to other embodiments of the disclosure.

FIG. 6 is a schematic structural view of a molding mold according to embodiments of the disclosure.

### DETAILED DESCRIPTION OF EMBODIMENTS

The disclosure discloses a molding mold. A plurality of first molding portions 12 are connected to each other via first connection portions 14 located therebetween, such that the first surface 11 forms a continuous molding surface for hot-pressing an entire sheet of flat glass, and the first molding portions 12 and the first connection portions 14 are integrally formed; and a plurality of second molding portions 22 are connected to each other via second connection portions 24 located therebetween, such that the second surface 21 forms a continuous molding surface for hot-pressing an entire sheet of flat glass in cooperation with the first surface 11, and the second molding portions 22 and the second connection portions 24 are integrally formed. Thus, the molding mold can press an entire sheet of glass at once to form a lens array. In addition, a plurality of first flow baffles 13 are disposed on a peripheral area of the first pressing mold 1, and protrude towards the second pressing mold 2 from the first surface 11. In this way, by providing the plurality of first flow baffles 13 outside the cavity regions of the first molding portions 12 and the second molding portions 22, glass may be prevented from flowing toward external directions of the molding regions, so that molding pressures outside the molding regions during manufacturing of lenses can be increased, thereby increasing a peripheral molding pressure of the molding mold. This results in an increase in the molding pressure at the peripheral area of the molding mold, thereby achieving a balance between the molding pressures in the central and peripheral areas, thus contributing to an improved product yield.

A first surface 11 is located on a side of a first pressing mold 1 close to a second pressing mold 2. A second surface 21 is located on a side of the second pressing mold 2 close to the first pressing mold 1. A first molding portion 12 for molding the glass lens in the first pressing mold 1 is formed by bending from the first surface 11. A second molding portion 22 in the second pressing mold 2 corresponds to the first molding portion 12. The second molding portion 22 is formed by bending from the second surface 21. A plurality of first flow baffles 13 are provided at intervals in the first pressing mold 1. The first flow baffles 13 are close to an outer edge of the first pressing mold 1, and protrude towards the second pressing mold 2 from the first surface 11. In this way, by providing the plurality of first flow baffles 13 outside cavity regions of the first molding portion 12 and the second molding portion 22, a wafer may be prevented from flowing toward external directions of the cavity regions, so as to balance molding pressures inside and outside the cavity regions. Therefore, molding pressures outside the cavity regions during manufacturing of lenses can be increased, thereby increasing a peripheral molding pressure of the mold. As such, molding pressures inside and outside the cavity region are balanced, which is advantageous for improving yield of products. Therefore, technical effects of increasing a molding pressure outside the cavity region, balance of molding pressures inside and outside the cavity region, and improving yield of the products can be achieved.

Technical solutions in embodiments of the disclosure may be described with reference to the drawings for the embodiments of the disclosure more clearly and completely. Obviously, the embodiments described are only some embodiments rather than all embodiments of the disclosure. On the basis of the embodiments of the disclosure, all the other embodiments obtained by those skilled in the art fall into the scope of the disclosure. The key term of “and/or” in the disclosure presents two conditions, “and” and “or”. That is, the expression “A and/or B” disclosed in the disclosure represents two conditions “A and B” and “A or B”. The expression “A and/or B” describes three status: only A is included, only B is included, and both A and B are included.

It would be appreciated that although terms “first”, “second” and the like herein may be used to describe different elements, components, regions, layers, and/or portions, these elements, components, regions, layers, and/or portions should not be limited by these terms. The terms are only used for distinguish one element, component, region, layer, or portion from another element, component, region, layer, or portion. Therefore, without departing from the teaching of the exemplary embodiments, a first element, component, region, layer, or portion described in the following may be also called as a second element, component, region, layer, or portion. Herein, space terms such as “lower” and “upper” may be used, in order to describe a relationship between one element or feature and another element or feature. It may be appreciated that besides the locations shown in the drawings, space terms further include directions of devices during use or operation. For example, if a device in the drawings is reverted, an element or feature referred to as “lower” would be taken as “upper” element or feature. Therefore, the exemplary term “lower” may include the upper and lower directions. The device may be relocated (be rotated by 90 degrees or in another direction), and a reference sign for space description may be described accordingly.

In addition, in the disclosure, if a component is considered to be “fixed to” another component, the component may be directly disposed on the another component or there may be a middle component between them. If a component is considered to be “connected” to another component, the component may be directly connected to the another component or there may be a middle component between them. If a component is considered to be “provided on” another component, the component may be directly provided on the another component or there may be a middle component between them. Terms such as “vertical”, “horizontal”, “left”, “right” used in the embodiments in the disclosure are merely intended to describe the disclosure rather than limit the disclosure.

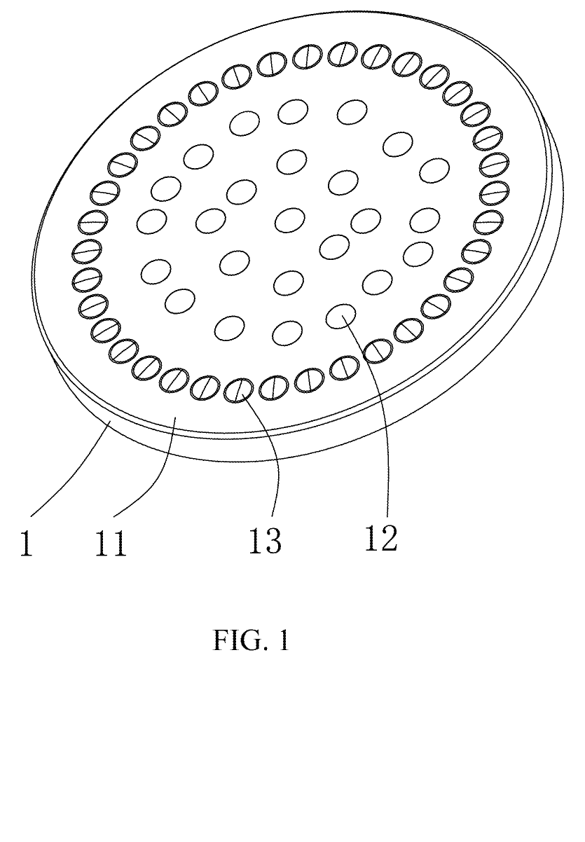

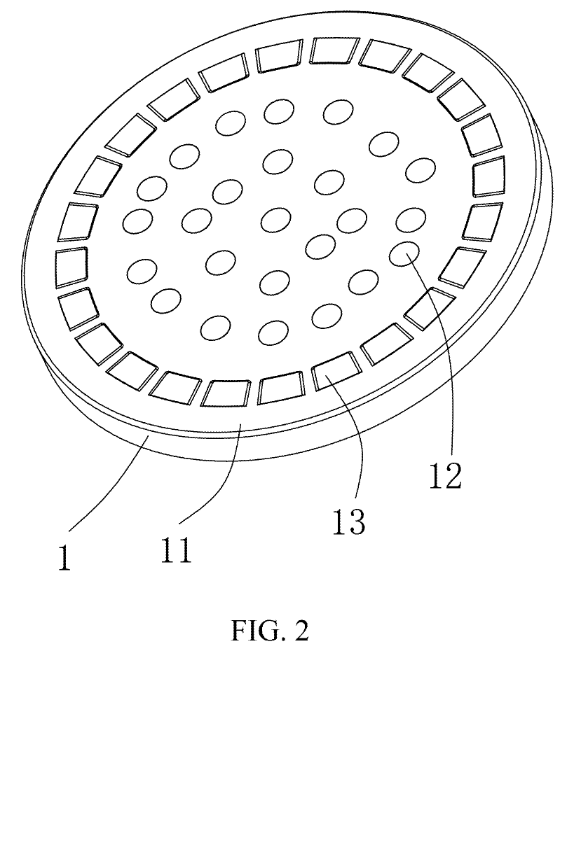

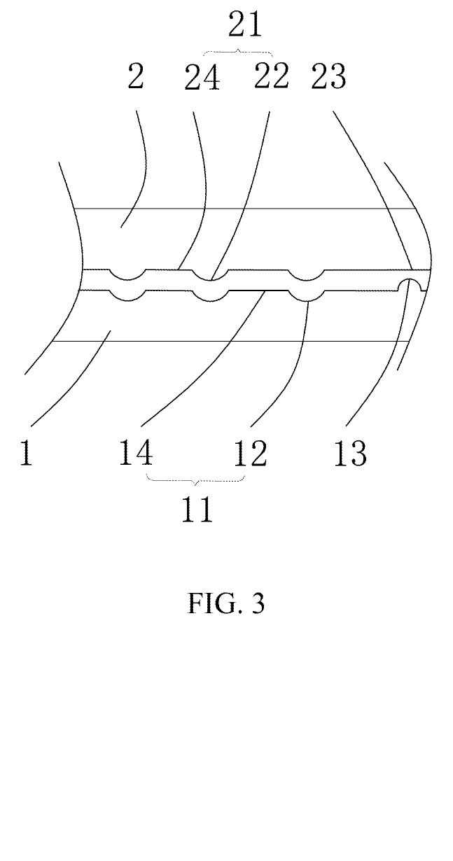

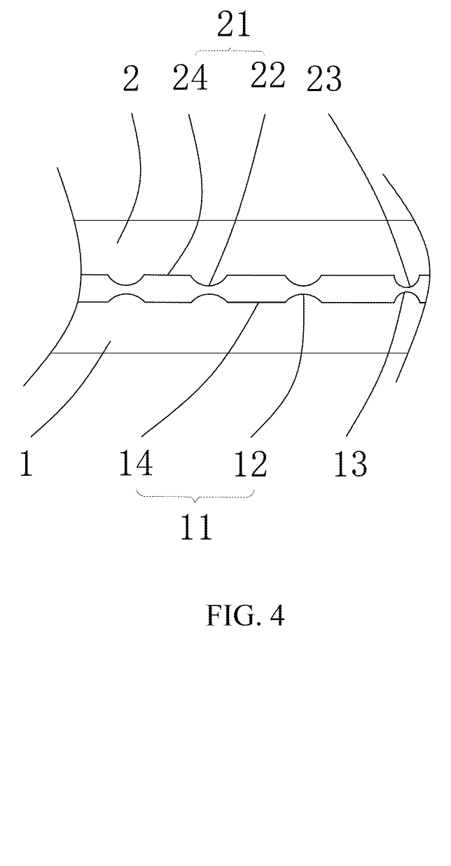

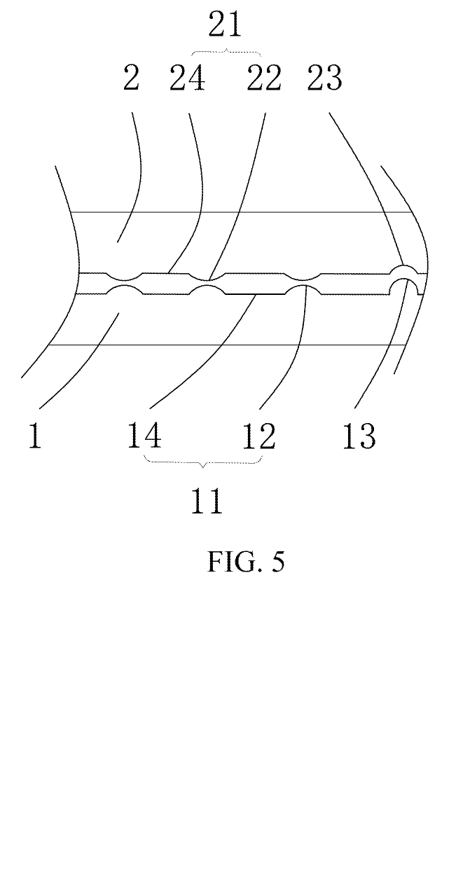

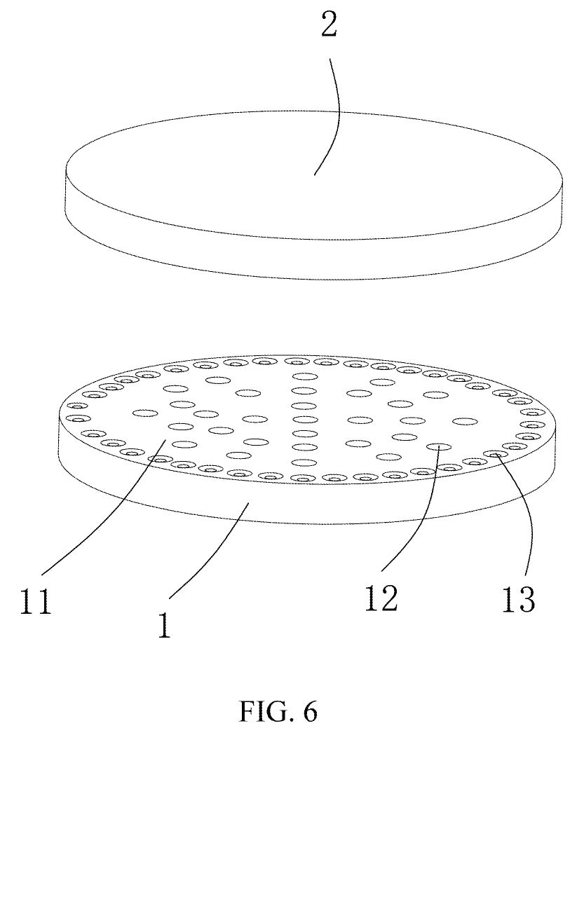

With reference to FIG. 1 and FIG. 2, FIG. 1 is a schematic view of a molding mold according to according to embodiments of the disclosure. FIG. 2 is a schematic view of a molding mold according to other embodiments of the disclosure. FIG. 3 is a first schematic view of a first flow baffle 13 and a second hydraulic resistance 23 in a molding mold according to embodiments of the disclosure. FIG. 4 is a second schematic view of the first flow baffle 13 and the second hydraulic resistance 23 in the molding mold according to other embodiments of the disclosure. FIG. 5 is a third schematic view of the first flow baffle 13 and the second hydraulic resistance 23 in the molding mold according to other embodiments of the disclosure. FIG. 6 is a structural diagram of a molding mold according to embodiments of the disclosure. The disclosure discloses a molding mold. The molding mold is specifically described as follows.

The first pressing mold 1 having the first surface 11 and the second pressing mold 2 having the second surface 21 are described as follows.

The first surface 11 is located on the side of the first pressing mold 1 close to the second pressing mold 2. The second surface 21 is located om the side of the second pressing mold 2 close to the first pressing mold 1. The first pressing mold 1 includes the first molding portion 12 for molding a glass lens. The first molding portion 12 is formed by bending from the first surface 11. For example, the first molding portion 12 is formed by forming a concave shape on the first surface 11 by bending the first surface 11 in a direction away from the second surface 21, or by forming a convex shape on the first surface 11 by bending the first surface 11 in a direction close to the second surface 21. The second pressing mold 2 includes the second molding portion 22 corresponding to the first molding portion 12. The second molding portion 22 is formed by bending from the second surface 21. For example, the second molding portion 22 is formed by forming a concave shape on the second surface 21 by bending the second surface 21 in a direction away from the first surface 11, or by forming a convex shape on the second surface 21 by bending the second surface 21 in a direction close to the first surface 11. Each of the first molding portions 12 and one of the second molding portions 22 aligned therewith cooperate to define a lens cavity

In particular, there is a space defined between the first surface 11 and the second surface 21 for accommodating a glass lens. Specifically, there is a space for molding the glass lens defined between the first molding portion 12 on the first surface 11 and the second molding portion 22 on the second surface 21. For example, the glass lens may be molded and formed through mutual compression between the first molding portion 12 provided on the first surface 11 and the second molding portion 22 provided on the second surface 21.

The first pressing mold 1 further includes a plurality of first connection portions 14. The plurality of first molding portions 12 are connected to each other via the first connection portions 14 located therebetween, such that the first surface 11 forms a continuous molding surface for hot-pressing an entire sheet of flat glass. The plurality of first molding portions 12 and the plurality of first connection portions 14 are integrally formed. The second pressing mold 2 includes a plurality of second connection portions 24. The plurality of second molding portions 22 are connected to each other via the second connection portions 24 located therebetween, such that the second surface 21 forms a continuous molding surface for hot-pressing mold a single sheet of flat glass in cooperation with the first surface 11. The plurality of second molding portions 22 and the plurality of second connection portions 24 are integrally formed.

The first surface 11 defines a cavity region to form the first molding portion 12. That is, the first molding portion 12 is located in the cavity region. The first flow baffles 13 are provided outside the cavity region. The first flow baffle 13 is configured to restrict glass flow during a hot-pressing process, so as to balance the molding pressure of the molding mold from a center to a peripheral area. The second surface 21 defines a cavity region to form the second molding portion 22. That is, the second molding portion 22 is located in the cavity region. The second flow baffles 23 are provided outside the cavity region. Similarly, the second flow baffle 23 is also configured to restrict glass flow during a hot-pressing process, so as to balance the molding pressure of the molding mold from a center to a peripheral area

The plurality of first flow baffles 13 included in the first pressing mold 1 that are spaced apart from each other and the plurality of second flow baffles 23 included in the second pressing mold 2 that are spaced apart from each other are described as follows.

The first flow baffles 13 are provided close to the outer edge of the first pressing mold 1 and protrude towards the second pressing mold 2 from the first surface 11. In a direction perpendicular to the first surface 11, a junction of each the first flow baffles 13 and the first surface 11 has a circular or a fan-ring shape. There are an even number of the first flow baffles 13 and the even number of first flow baffles 13 are provided around a center of the first surface 11. The second flow baffles 23 are provided corresponding to the first flow baffles 13. The second flow baffles 23 protrude towards the first pressing mold 1 from the second surface 21. The second flow baffles 23 are recessed in the second surface 21 in a direction away from the first pressing mold 1. A size of each of the plurality of first flow baffles 13 protruding from the first surface 11 is greater than a size of a a corresponding second flow baffle 23 recessed in the second surface 21. In a direction perpendicular to the second surface 21, a junction of each of the second flow baffles 23 and the second surface 21 has a circular or a fan-ring shape. There are an even number of the second flow baffles 23 and the even number of the second flow baffles 23 are provided around a center of the second surface 21.

In particular, the plurality of first flow baffles 13 are provided in the first pressing mold 1. All the plurality of first flow baffles 13 are connected with the first surface 11. In the direction perpendicular to the first surface 11, a cross section of the junction of each of the first flow baffles 13 and the first surface 11 may have a circular shape or a fan-ring shape. The plurality of first flow baffles 13 may refer to an even number of first flow baffles 13, such as two first flow baffles 13, four first flow baffles 13, or six first flow baffles 13. The first surface 11 may have a circular shape. A central point of the plurality of first flow baffles 13 is the same as a center of the first surface 11. The plurality of first flow baffles 13 form a ring close to the outer edge of the first pressing mold 1. Each two adjacent first flow baffles 13 have an equal distance therebetween. The second flow baffles 23 on the second surface 21 and the first flow baffles 13 are in one-to-one correspondence. In the direction perpendicular to the second surface 21, a cross section of a junction of each of the second flow baffles 23 and the second surface 21 may have a circular shape or a fan-ring shape. The number of the second flow baffles 23 may be the same as the number of the first flow baffles 13. The second surface 21 may be a circle. A central point of the plurality of second flow baffles 23 is the same as a center of the second surface 21. The plurality of second flow baffles 23 form a ring close to the outer edge of the second pressing mold 2. Each two adjacent second flow baffles 23 have an equal distance therebetween. Therefore, during manufacturing of the lenses, the peripheral molding pressure of the mold can be increased through the plurality of first flow baffles 13 provided close to the outer edge of the first pressing mold 1 and the second flow baffles 23 provided on the second surface 21 and respectively corresponding to the first flow baffles 13.

To specifically describe configuration of the first flow baffles 13 and the second flow baffles 23, following implementations are provided. In a first implementation, the first flow baffles 13 protrude towards the second pressing mold 2 from the first surface 11, and the second flow baffles 23 are substantially flush with the second surface 21. In a second implementation, the first flow baffles 13 protrude towards the second pressing mold 2 from the first surface 11, and the second flow baffles 23 protrude towards the first pressing mold 1 from the second surface 21. In a third implementation, the first flow baffles 13 protrude toward the second pressing mold 2 from the first surface 11, the second flow baffles 23 are recessed in the second surface 21 in a direction away from the first pressing mold 1, and a size of each of the first flow baffles 13 protruded is greater than a size of a corresponding second flow baffle 23 recessed. After the first molding portion 12 and the second molding portion 12 get close to each other, molding pressures inside and outside the glass lens between the first surface 11 and the second surface 21 are balanced through the plurality of first flow baffles 13 and the plurality of second flow baffles 23, which is advantageous for improving yield of products.

In the mold mold, the plurality of first molding portions 12 are connected to each other via the first connection portions 14 located therebetween, such that the first surface 11 forms a continuous molding surface for hot-pressing an entire sheet of flat glass, and the first molding portions 12 and the first connection portions 14 are integrally formed; and the plurality of second molding portions 22 are connected to each other via the second connection portions 24 located therebetween, such that the second surface 21 forms a continuous molding surface for hot-pressing an entire sheet of flat glass in cooperation with the first surface 11, and the second molding portions 22 and the second connection portions 24 are integrally formed. Thus, the molding mold can press an entire sheet of glass at once to form a lens array. In addition, a plurality of first flow baffles 13 are disposed on a peripheral area of the first pressing mold 1, and protrude towards the second pressing mold 2 from the first surface 11. In this way, by providing the plurality of first flow baffles 13 outside the cavity regions of the first molding portions 12 and the second molding portions 22, glass may be prevented from flowing toward external directions of the molding regions, so that molding pressures outside the molding regions during manufacturing of lenses can be increased, thereby increasing a peripheral molding pressure of the molding mold. This results in an increase in the molding pressure at the peripheral area of the molding mold, thereby achieving a balance between the molding pressures in the central and peripheral areas, thus contributing to an improved product yield.

The disclosure further provides a method for manufacturing a glass lens, including the following steps of:

S1: providing a molding mold as described above. The molding mold is subjected to pre-treatment processes such as cleaning and preheating. Simultaneously, an entire sheet of flat glass that meets requirements is prepared as the glass substrate.

S2: placing the entire sheet of flat glass on the first surface of the first pressing mold, and then driving the first pressing mold and the second pressing mold to move toward each other until the mold is fully closed.

S3: closing the mold, and heating the mold and the glass to a predetermined molding temperature near the softening point of the glass, thereby softening the flat glass. Subsequently, a predetermined molding pressure is applied. Under the combined action of temperature and pressure, the softened glass material fills the product cavities defined together by the plurality of first molding portions and second molding portions. Consequently, a plurality of lenses are molded in a single pressing operation. These lenses are connected by connection bridges formed by the first connection portions and the second connection portions, constituting a complete glass lens array. Herein, during the hot-pressing process, the first flow baffles 13 restrict the flow of the softened flat glass to balance the molding pressure from the center to the peripheral area of the molding mold.

S4: performing a controlled cooling process after the pressing to solidify and mold the glass. Optionally, an annealing process is performed to relieve internal stresses therein.

S5: cooling the mold to a safe temperature, and then opening the mold and taking out the molded glass lens array.

S6: securing the glass lens array, and separating individual lenses by laser cutting to obtain the final individual glass lens products.

It shall be noted that the above implementations are only for describing rather than limiting the technical solutions in the disclosure. Although the disclosure is specifically described with reference to examples, those of ordinary skilled shall understand that the technical solution in the disclosure may be amended or equivalently substituted without going beyond the spirit and scope of the technical solution in the disclosure, but the technical solution in the disclosure shall be covered within the scope of the claims in the disclosure.

What is claimed is:

1. A molding mold, comprising a first pressing mold and a second pressing mold opposite to each other, wherein the first pressing mold has a first surface facing the second pressing mold, and the first surface of the first pressing mold is provided with a plurality of first molding portions for molding glass lenses; and the second pressing mold has a second surface facing the first pressing mold, and the second surface of the second pressing mold is provided with a plurality of second molding portions for molding the glass lenses,
wherein each of the plurality of first molding portions and one of the plurality of second molding portions aligned therewith cooperate to define a lens cavity,
wherein the first pressing mold further comprises a plurality of first connection portions, and any two adjacent first molding portions among the plurality of first molding portions are connected through one of the plurality of first connection portions located therebetween, so that the first surface forms a continuous molding surface for hot-pressing an entire sheet of flat glass; and
the second pressing mold further comprises a plurality of second connection portions, and any two adjacent second molding portions among the plurality of second molding portions are connected through one of the plurality of second connection portions located therebetween, so that the second surface forms a continuous molding surface for hot-pressing the entire sheet of flat glass in cooperation with the first surface,
wherein the plurality of first molding portions and the plurality of first connection portions are integrally formed, and the plurality of second molding portions and the plurality of second connection portions are integrally formed,
wherein the first pressing mold further comprises a plurality of first flow baffles spaced apart from each other, the plurality of first flow baffles are disposed on a peripheral area of the first pressing mold and protrude towards the second pressing mold from the first surface, and the plurality of first flow baffles are configured to restrict glass flow during a hot-pressing process, so as to balance molding pressure of the molding mold from a center to the peripheral area.

2. The molding mold according to claim 1, wherein the second pressing mold further comprises a plurality of second flow baffles spaced apart from each other, and the second flow baffles are provided corresponding to the plurality of first flow baffles.

3. The molding mold according to claim 2, wherein the plurality of second flow baffles protrude towards the first pressing mold from the second surface.

4. The molding mold according to claim 2, wherein the plurality of second flow baffles are recessed in the second surface in a direction away from the first pressing mold, and a size of each of the plurality of first flow baffles protruding from the first surface is greater than a size of a corresponding second flow baffle of the plurality of second flow baffles recessed in the second surface.

5. The molding mold according to claim 1, wherein in a direction perpendicular to the first surface, a junction of each of the plurality of first flow baffles and the first surface has a circular shape or a fan-ring shape.

6. The molding mold according to claim 5, wherein the plurality of first flow baffles are configured as an even number of first flow baffles, and the even number of first flow baffles are provided around a center of the first surface.

7. The molding mold according to claim 3, wherein in a direction perpendicular to the second surface, a junction of each of the plurality of second flow baffles and the second surface has a circular shape or a fan-ring shape.

8. The molding mold according to claim 7, wherein the plurality of second flow baffles are configured as an even number of second flow baffles, and the even number of second flow baffles are provided around a center of the second surface.

9. The molding mold according to claim 4, wherein in a direction perpendicular to the second surface, a junction of each of the plurality of second flow baffles and the second surface has a circular shape or a fan-ring shape.

10. The molding mold according to claim 9, wherein the plurality of second flow baffles are configured as an even number of second flow baffles, and the even number of second flow baffles are provided around a center of the second surface.

11. A method for manufacturing a glass lens, comprising:
providing a molding mold, wherein the molding mold comprises a first pressing mold and a second pressing mold opposite to each other, wherein the first pressing mold has a first surface facing the second pressing mold, and provided with a plurality of first molding portions for molding glass lenses, and the second pressing mold has a second surface facing the first pressing mold, and provided with a plurality of second molding portions for molding the glass lenses;
placing an entire sheet of flat glass between the first pressing mold and the second pressing mold;
closing the molding mold and heating the molding mold, so that the flat glass softens and is pressed at the plurality of first molding portions and the plurality of second molding portions to form a plurality of lenses, wherein the first pressing mold further comprises a plurality of first flow baffles spaced apart from each other, the plurality of first flow baffles are disposed on a peripheral area of the first pressing mold and protrude towards the second pressing mold from the first surface, and the plurality of first flow baffles are configured to restrict a flow of the softened flat glass during a hot-pressing process, so as to balance molding pressure of the molding mold from a center to the peripheral area;
opening the molding mold and taking out the molded plurality of lenses; and
separating individual lenses by laser cutting,
wherein each of the plurality of first molding portions and one of the plurality of second molding portions aligned therewith cooperate to define a lens cavity,
wherein the first pressing mold further comprises a plurality of first connection portions, and any two adjacent first molding portions among the plurality of first molding portions are connected through one of the plurality of first connection portions located therebetween, so that the first surface forms a continuous molding surface for hot-pressing an entire sheet of flat glass; and
the second pressing mold further comprises a plurality of second connection portions, and any two adjacent second molding portions among the plurality of second molding portions are connected through one of the plurality of second connection portions located therebetween, so that the second surface forms a continuous molding surface for hot-pressing the entire sheet of flat glass in cooperation with the first surface,
wherein the plurality of first molding portions and the plurality of first connection portions are integrally formed, and the plurality of second molding portions and the plurality of second connection portions are integrally formed.
